(19) United States
(12) Patent Application Publication
(10) Pub. No.: US 2007/0229411 A1
(43) Pub. Date: Oct. 4, 2007

(54) PIXEL AND ORGANIC LIGHT EMITTING DISPLAY DEVICE USING THE PIXEL

(76) Inventor: Sang Moo Choi, Suwon (KR)

Correspondence Address: CHRISTIE, PARKER & HALE, LLP, PO BOX 7068, PASADENA, CA, 91109-7068, US

(21) Appl. No.: 11/688,163

(22) Filed: Mar. 19, 2007

(30) Foreign Application Priority Data
Mar. 28, 2006 (KR) 10-2006-0027826

(51) Int. Cl. G09G 3/30

(52) U.S. Cl. 345/76

(57) ABSTRACT

An organic light emitting display device pixel includes an organic light emitting diode (OLED). First, second and third transistors each have first, second and gate electrodes. A storage capacitor is connected between a power source and the first transistor gate electrode. A power source line is connected with a cathode electrode of the OLED for providing a voltage of either a high state or a low state. The second transistor is connected with a data line and a scan line and is turned on when a scan signal is supplied to the scan line. The first transistor is connected between the second transistor second electrode and an anode electrode of the OLED. The third transistor is connected between the gate and second electrodes of the first transistor and is turned on when the scan signal is supplied to the scan line.

### CROSS-REFERENCE TO RELATED APPLICATIONS

This application claims priority to and the benefit of Korean Patent Application No. 10-2006-0027826, filed on Mar. 28, 2006, in the Korean Intellectual Property Office, the entire content of which is incorporated herein by reference.

### BACKGROUND

1. Field of the Invention

The present invention relates to a pixel and an organic light emitting display device using the pixel, and, more particularly, to a pixel and an organic light emitting display device using the pixel which has a minimal number of transistors to display images of uniform brightness.

2. Discussion of Related Art

One type of flat panel display device is an organic light emitting display device which displays an image by using an organic light emitting diode (OLED). The OLED generates light by recombining electrons and holes. Advantages of the organic light emitting display device include low power consumption as well as rapid response speed.

FIG. 1 is a circuit diagram showing a pixel of a conventional organic light emitting display device.

Referring to FIG. 1, the pixel 4 includes a pixel circuit 2 connected to an OLED, to a data line Dm, and to a scan line Sn for controlling the OLED.

An anode electrode of the OLED is connected with the pixel circuit 2, and a cathode electrode of the OLED is connected to a power source ELVSS. The OLED generates light of a certain or predetermined brightness corresponding to a level of a current supplied to the OLED from the pixel circuit 2.

The pixel circuit 2 controls the level of the current supplied to the OLED corresponding to a data signal supplied to the data line Dm, when a scan signal is supplied to the scan line Sn. In more detail, the pixel circuit 2 includes a first transistor M11 and a second transistor M12. The second transistor M12 is connected between a power source ELVDD and the OLED. The first transistor M11 is connected with the second transistor M12, with the data line Dm, and with the scan line Sn. The pixel circuit 2 further includes a storage capacitor C1st connected between a gate electrode and a first electrode of the second transistor M12.

A gate electrode of the first transistor M11 is connected with the scan line Sn, and a first electrode of the first transistor M11 is connected with the data line Dm. A second electrode of the first transistor M11 is connected with a first terminal of the storage capacitor C1st. Either a source electrode or a drain electrode of the transistor M11 may be selected as the first electrode, and, of the source electrode and the drain electrode, the electrode not selected as the first electrode is selected as the second electrode. For example, if the source electrode is chosen as the first electrode, the drain electrode is chosen as the second electrode. The first transistor M11 is turned on to supply the data signal supplied to the data line Dm to the storage capacitor C1st, when the scan signal is supplied to the scan line Sn. Then, the storage capacitor C1st is charged according to a voltage of the data signal.

The gate electrode of the second transistor M12 is connected with a second terminal of the storage capacitor C1st, and the first electrode of the second transistor M12 is connected with the first terminal of the storage capacitor C1st and with the power source ELVDD. A second electrode of the second transistor M12 is connected with the anode electrode of the OLED. The second transistor M12 controls the level of the current flowing into the power source ELVSS via the OLED from the power source ELVDD according to a level of a voltage stored in the storage capacitor C1st. Then, the OLED generates light according to the level of the current supplied from the second transistor M12.

However, the pixel 4 of the conventional organic light emitting display device may display images that are not of uniform brightness. In more detail, a threshold voltage of the second transistor M12 can be different from threshold voltages of corresponding transistors of other pixels of the conventional organic light emitting display device. The differences may arise from process deviation and other manufacturing-related factors. If corresponding threshold voltages vary across a plurality of pixels of an organic light emitting display device, even when the plurality of pixels are supplied with a data signal corresponding to a same gray scale, light generated by corresponding OLEDs of the plurality of pixels may be of variable brightness due to the variations between the corresponding threshold voltages across the plurality of pixels.

### SUMMARY OF THE INVENTION

An aspect of the present invention is to provide a pixel and organic light emitting display using the pixel, the pixel using a minimal number of transistors to displaying an image of uniform brightness.

In one embodiment of the present invention, a pixel includes an organic light emitting diode (OLED) having a cathode electrode and an anode electrode. A first transistor has a first transistor first electrode, a first transistor second electrode, and a first transistor gate electrode. A second transistor has a second transistor first electrode, a second transistor second electrode, and a second transistor gate electrode. A third transistor has a third transistor first electrode, a third transistor second electrode, and a third transistor gate electrode. A storage capacitor is connected between a first power source and the first transistor gate electrode. The storage capacitor has a storage capacitor first terminal and a storage capacitor second terminal. A power source line is connected with the cathode electrode of the OLED for providing one of a voltage of a high state and a voltage of a low state. The second transistor is connected with a data line and a scan line and is turned on when a scan signal is supplied to the scan line. The first transistor is connected between the second transistor second electrode and the anode electrode of the OLED. The third transistor is connected between the first transistor gate electrode and the first transistor second electrode and is turned on when the scan signal is supplied to the scan line.

In a further embodiment, the scan signal is supplied to the scan line during a period, and the power source line provides the voltage of the low state during a first portion of the period to provide a voltage corresponding to the voltage of the low state at the first transistor gate electrode. The power source line provides the voltage of the high state during a second portion of the period to provide a voltage corresponding to a data signal supplied to the data line at the storage capacitor first terminal. The voltage corresponding to the data signal provides a charging voltage to the storage capacitor. The first portion of the period and the second portion of the period are non-overlapping.

In a further embodiment, the pixel includes a fourth transistor having a fourth transistor first electrode, a fourth transistor second electrode, and a fourth transistor gate electrode. The fourth transistor is connected between the first power source and the first transistor first electrode. The fourth transistor gate electrode is connected with a light emitting control line. The fourth transistor is turned off when a light emitting control signal is supplied to a light emitting control line.

In another embodiment of the present invention, an organic light emitting display includes a scan driver for supplying scan signals to scan lines in a sequential order and for supplying light emitting control signals to light emitting control lines in a sequential order. A data driver supplies data signals to data lines. A plurality of pixels are arranged such that each of the pixels is connected with a corresponding one of the scan lines and a corresponding one of the data lines. A power supplier supplies a voltage of a high state to a plurality of power source lines in a sequential order and to supply a voltage of a low state to power source lines of the plurality of power source lines not supplied with the voltage of the high state. Each of the plurality of power source lines is connected with the cathode electrode of the organic light emitting diode of a corresponding pixel of the plurality of pixels.

In an exemplary embodiment, the scan driver supplies one of the scan signals to a corresponding one of the scan lines during a first period and supplies a corresponding one of the light emitting control signals to a corresponding one of the light emitting control lines during a second period. The first period overlaps with the second period. The power supplier supplies the voltage of the high state to a corresponding one of the power source lines beginning at a time in the first period. The power supplier supplies the voltage of the low state to the corresponding one of the power source lines after the first period has ended.

### BRIEF DESCRIPTION OF THE DRAWINGS

FIG. 1 is a circuit diagram showing a pixel of a conventional organic light emitting display device.

FIG. 2 is a diagram showing an organic light emitting display device according to a first embodiment of the present invention.

FIG. 3 is a circuit diagram showing a pixel of the organic light emitting display device of the first embodiment.

FIG. 4 is a waveform diagram corresponding to a method of driving the pixel of the organic light emitting display device of the first embodiment.

FIG. 5 is a diagram showing an organic light emitting display device according to a second embodiment of the present invention.

FIG. 6 is a circuit diagram showing a pixel of the organic light emitting display device of the second embodiment.

FIG. 7 is a waveform diagram corresponding to a method of driving the pixel of the organic light emitting display device of the second embodiment.

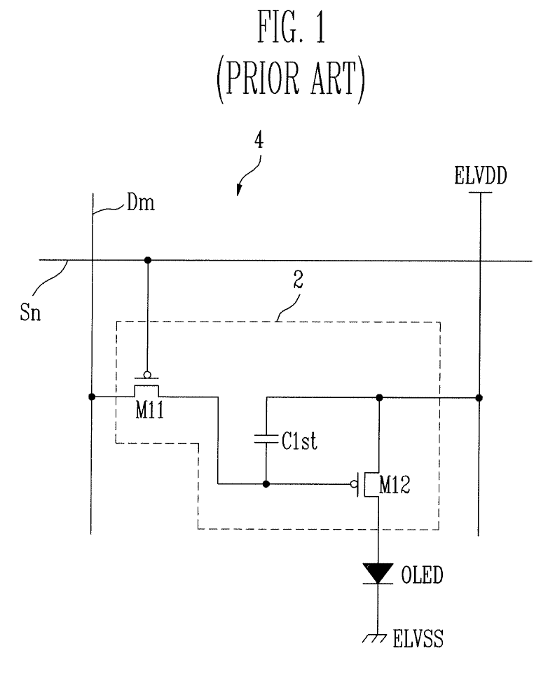

### DETAILED DESCRIPTION

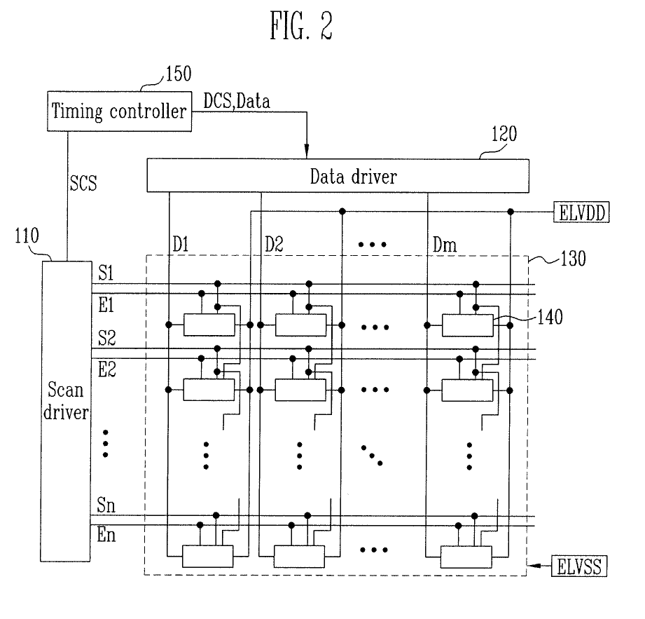

Referring to FIG. 2, an organic light emitting display device according to a first embodiment of the present invention includes: a pixel unit 130 including a plurality of pixels 140, each of which is arranged to be connected with one or more scan lines S1, S2, . . . , Sn and with one of data lines D1, D2, . . . , Dm; a scan driver 110 for driving the scan lines S1, S2, . . . , Sn and light emitting control lines E1, E2, . . . , En; a data driver 120 for driving the data lines D1, D2, . . . , Dm; and a timing controller 150 for controlling the scan driver 110 and the data driver 120.

The scan driver 110 receives scan driving control signals SCS from the timing controller 150. The scan driver 110 generates scan signals and supplies the scan signals to the scan lines S1, S2, . . . , Sn in a sequential order. Also, the scan driver 110 generates light emitting control signals according to the scan driving control signals and supplies the light emitting control signals to the light emitting control lines E1, E2, . . . , En in a sequential order. A respective width of each of the light emitting control signals is set to be substantially equal to or larger than a width of a corresponding one or more of the scan signals.

The data driver 120 receives data driving control signals DCS from the timing controller 150. The data driver 120 generates data signals that are synchronized with the scan signals and supplies the data signals to the data lines D1, D2, . . . , Dm.

The timing controller 150 generates the data driving control signals DCS and the scan driving control signals SCS according to synchronization signals, which, in a further embodiment, are externally provided. The data driving control signals SCS and the scan driving control signals SCS are supplied to the data driver 120 and to the scan driver 110, respectively. The timing controller 150 receives externally provided data and supplies the data to the data driver 120.

The pixel unit 130 receives a voltage corresponding to a first power source ELVDD and a voltage corresponding to a second power source ELVSS (which, in a further embodiment, may be an external source) and supplies both voltages to each pixel 140. Each of the pixels 140 receives the voltages and generates light according to the data signals. Durations of periods in which the pixels generate light are controlled according to the light emitting control signals.

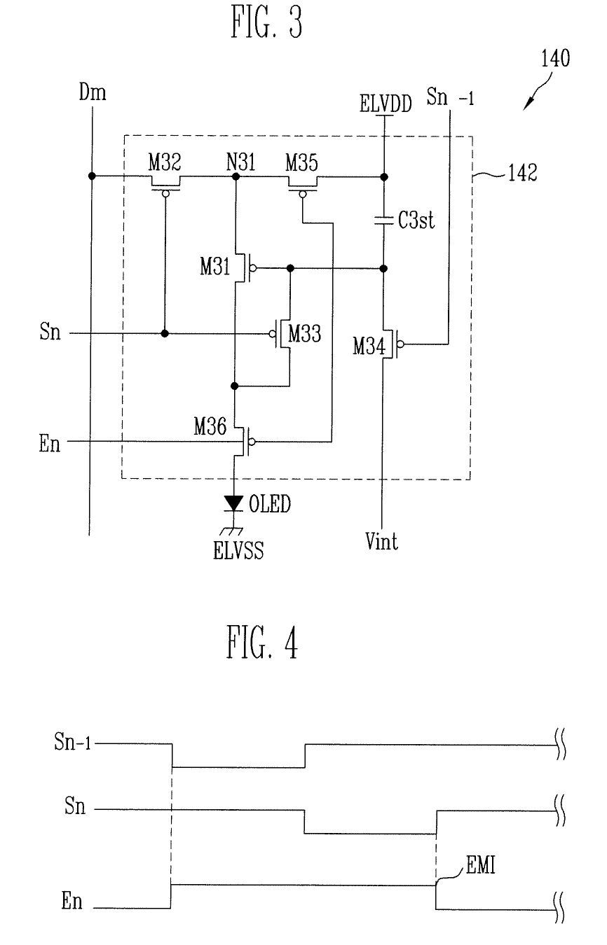

FIG. 3 is a circuit diagram showing an embodiment of the pixel of the first embodiment of the present invention. For purposes of explanation, FIG. 3 shows the m^{th} data line Dm, the n^{th} scan line Sn, the (n−1)^{th} scan line Sn−1, and the n^{th} light emitting control line En.

Referring to FIG. 3, the pixel 140 includes an organic light emitting diode (OLED) and a pixel circuit 142, which is connected to the data line Dm, the scan lines Sn−1 and Sn, and the light emitting control line En, for controlling a level of a current supplied to the OLED.

An anode electrode of the OLED is connected with the pixel circuit 142, and a cathode electrode of the OLED is connected with the second power source ELVSS. A level of the voltage corresponding to the second power source ELVSS is set to be lower than a level of the voltage corresponding to the first power source ELVDD. Accordingly, a brightness at which the OLED generates light corresponds to the level of the current supplied from the pixel circuit 142 to the OLED.

The pixel circuit 142 controls the level of the current supplied to the OLED according to the data signal supplied to the data line Dm, when the scan signal is supplied to the scan line Sn. The pixel circuit 142 includes a first transistor M31, a second transistor M32, a third transistor M33, a fourth transistor M34, a fifth transistor M35, a sixth transistor M36, and a storage capacitor C3st.

A first electrode of the second transistor M32 is connected with the data line Dm, and a second electrode of the second transistor M32 is connected with a first node N31. A gate electrode of the second transistor M32 is connected with the scan line Sn. Accordingly, the second transistor M32 is turned on to supply the data signal supplied to the data line Dm to the first node N31, when the scan signal is supplied to the scan line Sn.

A first electrode of the first transistor M31 is connected with the first node N31, and a second electrode of the first transistor M31 is connected with a first electrode of the sixth transistor M36. A gate electrode of the first transistor M31 is connected with a first terminal of the storage capacitor C3st. Accordingly, the first transistor M31 supplies current to the OLED via the sixth transistor M36 according to a voltage stored in the storage capacitor C3st.

A first electrode of the third transistor M33 is connected with the second electrode of the first transistor M31, and a second electrode of the third transistor M33 is connected with the gate electrode of the first transistor M31. A gate electrode of the third transistor M33 is connected to the scan line Sn. Accordingly, the third transistor M33 is turned on to connect the first transistor M31 in a diode form, when the scan signal is supplied to the scan line Sn.

A gate electrode of the fourth transistor M34 is connected with the scan line Sn−1, and a first electrode of the fourth transistor M34 is connected with the first terminal of the storage capacitor C3st and the gate electrode of the first transistor M31. A second electrode of the fourth transistor M34 is connected with an initialization power source Vint. Accordingly, the fourth transistor M34 is turned on to provide a voltage corresponding to the initialization power source Vint to the first terminal of the storage capacitor C3st and the gate electrode of the first transistor M31.

A first electrode of the fifth transistor M35 is connected with the first power source ELVDD, and a second electrode of the fifth transistor M35 is connected with the first node N31. A gate electrode of the fifth transistor M35 is connected with the light emitting control line En. Accordingly, the fifth transistor M35 is turned on to connect the first power source ELVDD with the first node N31, when the light emitting control signal is not supplied to the light emitting control line En.

The first electrode of the sixth transistor M36 is connected with the second electrode of the first transistor M31, and a second electrode of the sixth transistor M36 is connected with the anode electrode of the OLED. A gate electrode of the sixth transistor M36 is connected with the light emitting control line En. Accordingly, the sixth transistor M36 is turned on to supply the current supplied by the first transistor M31 to the OLED, when the light emitting control signal is not supplied to the light emitting control line En.

An operation of the pixel 140 will be described in more detail with reference to a waveform diagram shown in FIG. 4. First, the scan signal is supplied to the scan line Sn−1 to turn on the fourth transistor M34. If the fourth transistor M34 is turned on, the voltage corresponding to the initialization power source Vint is supplied to the first terminal of the storage capacitor C3st and the gate electrode of the first transistor M31. That is, if the fourth transistor M34 is turned on, the respective voltages at the first terminal of the storage capacitor C3st and at the gate electrode of the first transistor M31 are provided with the voltage corresponding to the initialization power source Vint. A level of the voltage corresponding to the initialization power source Vint is set to be lower than a level of a voltage corresponding to the data signal.

Then, the scan signal is supplied to the scan line Sn. Accordingly, the second transistor M32 and the third transistor M33 are turned on. If the third transistor M33 is turned on, the first transistor M31 is connected in the diode form. If the second transistor M32 is turned on, the data signal supplied to the data line Dm is supplied to the first node N31. Then, since the level of the voltage at the gate electrode of the first transistor M31 is brought to the level of the voltage corresponding to the initialization power source Vint which, as described earlier, is set to be lower than the level of the voltage corresponding to the data signal supplied to the first node N31, the first transistor M31 is turned on.

If the first transistor M31 is turned on, the data signal supplied to the first node N31 is supplied to the first terminal of the storage capacitor C3st via the first transistor M31 and the third transistor M33. Because the first transistor M31 is connected in the diode form, the storage capacitor C3st is charged according to a voltage corresponding to a threshold voltage of the first transistor M31 and the voltage corresponding to the data signal.

Then, the supplying of the light emitting control signal EM1 to the light emitting control line En is interrupted so that the fifth transistor M35 and the sixth transistor M36 are turned on. Accordingly, a current path is formed from the first power source ELVDD to the OLED. The first transistor M31 controls the amount of current flowing to the OLED from the first power source ELVDD according to a voltage stored in the storage capacitor C3st.

Because, as described earlier, the storage capacitor C3st was charged according to the voltage corresponding to the threshold voltage of the first transistor M31 as well as according to the voltage corresponding to the data signal, the first transistor M31 can better control the amount of current flowing to the OLED, regardless of the level of the threshold voltage of the first transistor M31. Therefore, the pixels 140 according to the first embodiment of the present invention can display images of uniform brightness, regardless of the level of the threshold voltage of the first transistor M31.

However, since each of the pixels 140 according to the first embodiment of the present invention includes six transistors, the structure of each pixel may be complicated. That is, when each of the pixels 140 includes six transistors, the size of each pixel 140 may be large, and the probability of failure or one or more of the transistors may be increased, thereby decreasing the reliability of each pixel. Furthermore, since the pixels 140 are connected with the initialization power source Vint via wires and also with one or more scan lines, the wiring configuration for each of the pixels may be complicated as well.

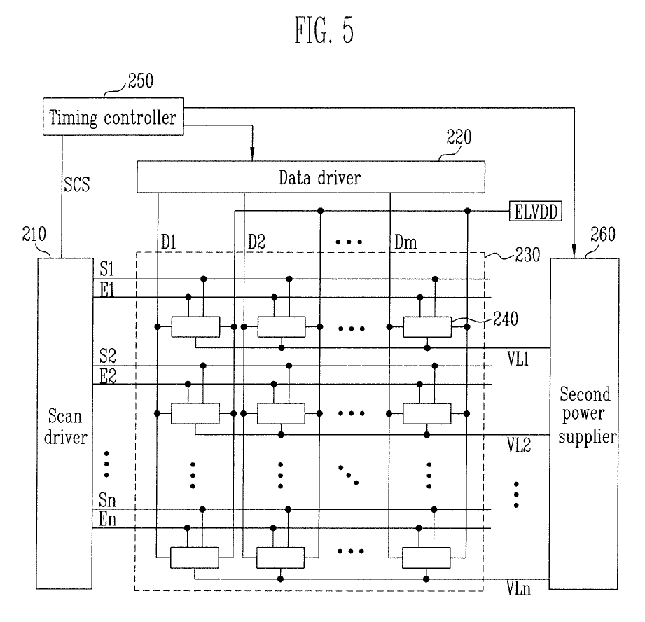

FIG. 5 is a diagram showing an organic light emitting display device according to a second embodiment of the present invention.

Referring to FIG. 5, the organic light emitting display device according to the second embodiment of the present invention includes: a pixel unit 230 including a plurality of pixels 240, each of which is arranged to be connected with one of scan lines S1, S2, . . . , Sn and with one of data lines D1, D2, . . . , Dm; a scan driver 210 for driving the scan lines S1, S2, . . . , Sn and light emitting control lines E1, E2, . . . , En; a data driver 220 for driving the data lines D1, D2, . . . , Dm; a second power supplier 260 for driving power source lines VL1, VL2, . . . , VLn; and a timing controller 250 for controlling the scan driver 210, the data driver 220, and the second power supplier 260.

The scan driver 210 generates scan signals subject to control by the timing controller 250 and supplies the scan signals to the scan lines S1, S2, . . . , Sn in a sequential order. Further, the scan driver 210 generates light emitting control signals subject to the control by the timing controller 250 and supplies the light emitting control signals to the light emitting control lines E1, E2, . . . , En in a sequential order. The light emitting control signal supplied to the i^{th} (where i represents a positive integer number) light emitting control line Ei overlaps with the scan signal supplied to the i^{th} scan line Si. In other words, the light emitting control signal is supplied to the light emitting control line Ei during at least the period over which the scan signal is supplied to the scan line Si.

The data driver 220 generates data signals subject to control by the timing controller 250 and supplies the data signals that are synchronized with the scan signals to the data lines D1, D2, . . . , Dm

The second power supplier 260 supplies a voltage from a second power source ELVSS to the power source lines VL1, VL2, . . . , VLn. A voltage of a high state ELVSS(H) is provided to the power source lines VL1, VL2, . . . , VLn in a sequential order. A voltage of a low state ELVSS(L) is provided to the power source lines other than the power source line receiving the voltage of the high state ELVSS(H) at a given time. Here, the voltage of the high state ELVSS(H) is supplied to the i^{th} power source line VLi is during a period overlapping with a period in which the light emitting control signal is supplied to the i^{th} light emitting control line Ei. In more detail, the voltage of the high state ELVSS(H) is supplied to the i^{th} power source line VLi beginning at a rising time point at which the scan signal is supplied to the i^{th} scan line Si and the light emitting control signal is supplied to the i^{th} light emitting control line Ei. The voltage of the low state ELVSS(L) is supplied to the i^{th} light emitting control line Ei after the supply of the light emitting control signal to the to i^{th} light emitting control line Ei is interrupted.

The timing controller 250 controls the scan driver 210, the data driver 220, and the second power supplier depending on synchronization signals that are externally provided.

The pixel unit 230 receives a voltage from a first power source ELVDD, which may be an external power source, and supplies the voltage to each of the pixels 240. According to a voltage of a corresponding data signal, each of the pixels 240 controls the amount of current flowing from the first power source ELVDD to the second power source ELVSS (when the second power source is providing the voltage of the low state to the pixel) via an OLED of the corresponding pixel.

In more detail, each of the pixels 240 shown in FIG. 5 is connected with one of the power source lines, the first power source ELVDD, one of the scan lines, one of the light emitting control lines, and one of the data lines. Accordingly, each of the pixels 240 shown in FIG. 5 is connected with five wires such that the wiring for each of the pixels 240 can be more simply implemented than for each of the pixels 140 shown in FIG. 2. As previously described, the pixels 140 shown in FIG. 2 require a more complicated wiring configuration of six wires per pixel.

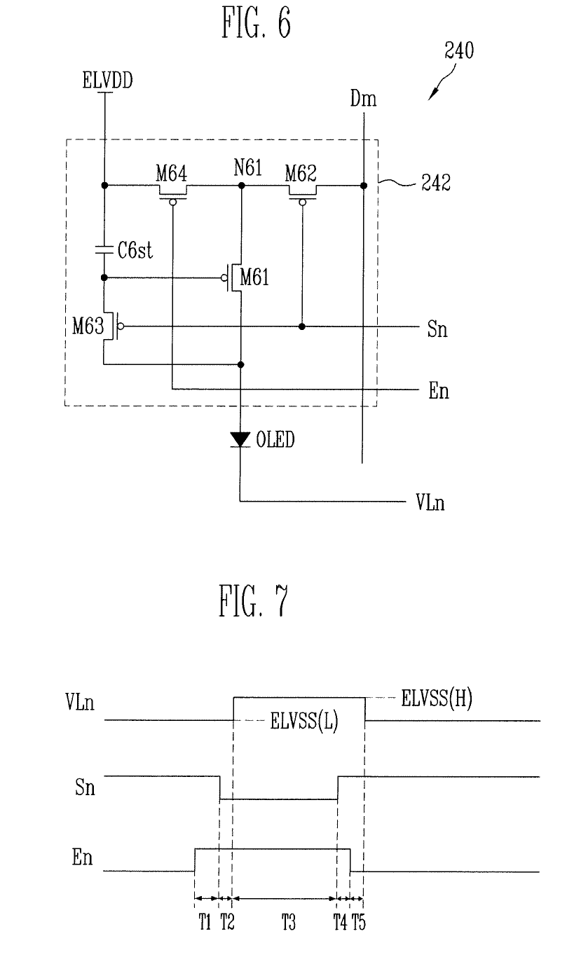

FIG. 6 is a circuit diagram showing an embodiment of the pixel of the second embodiment of the present invention. For purposes of explanation, FIG. 6 shows the m^{th} data line Dm, the n h scan line Sn, the n^{th} light emitting control line En, and the n^{th} power source line VLn.

Referring to FIG. 6, the pixel 240 includes an OLED, and a pixel circuit 242, which is connected to the data line Dm, the scan line Sn, and the light emitting control line En, for controlling the amount of current supplied to the OLED.

An anode electrode of the OLED is connected with the pixel circuit 142, and a cathode electrode of the OLED is connected with the power source line VLn. When the voltage of the low state ELVSS(L) is supplied to the power source line VLn, current is supplied from the pixel circuit 142 to the power source line VLn via the OLED, and the OLED generates a certain or predetermined light. Then, when the voltage of the high state ELVSS(H) is supplied to the power source line VLn, current does not flow to the OLED, and, accordingly, the OLED does not generate light. That is, a level of the voltage of the high state ELVSS(H) is set sufficiently high such that the current does not flow to the OLED when the voltage of the high state ELVSS(H) is supplied to the power source line VLn. By way of example, the level of the voltage of the high state ELVSS(H) may be set equal (or substantially equal) to a level of the voltage corresponding to the first power source ELVDD.

The pixel circuit 242 controls the amount of current supplied to the OLED corresponding to the data signal supplied to the data line Dm, when the scan signal is supplied to the scan line Sn. The pixel circuit 242 includes a first transistor M61, a second transistor M62, a third transistor M63, a fourth transistor M64, and the storage capacitor C6st.

A first electrode of the second transistor M62 is connected with the data line Dm, and a second electrode of the second transistor M62 is connected with the first node N61. A gate electrode of the second transistor M62 is connected with the scan line Sn. Accordingly, the second transistor M62 is turned on to supply the data signal supplied to the data line Dm to the first node N61, when the scan signal is supplied to the n scan line Sn.

A first electrode of the first transistor M61 is connected with the first node N61, and a second electrode of the first transistor M61 is connected with the anode electrode of the OLED. A gate electrode of the first transistor M61 is connected with a first terminal of the storage capacitor C6st. Accordingly, the first transistor M61 is turned on to supply the current to the OLED corresponding to a voltage stored in the storage capacitor C6st.

A first electrode of the third transistor M63 is connected with the second electrode of the first transistor M61, and a second electrode of the third transistor M63 is connected with the gate electrode of the first transistor M61. A gate electrode of the third transistor M63 is connected with the scan line Sn. Accordingly, the third transistor M63 is turned on to connect the first transistor in a diode form, when the scan signal is supplied to the scan line Sn.

A first electrode of the fourth transistor M64 is connected with the first power source ELVDD, and a second electrode of the fourth transistor M64 is connected with the first node N61. A gate electrode of the fourth transistor M64 is connected with the light emitting control line En. Accordingly, the fourth transistor M64 is turned on to electrically connect the first power source ELVDD with the first node N61, when the light emitting control signal is not supplied to the light emitting control line En.

An operation of the pixel will be described in detail with reference to the waveform diagram shown in FIG. 7. First, the light emitting control signal is supplied to the light emitting control line En during a first period T1 to turn off the fourth transistor M64. If the fourth transistor M64 is turned off, the first power source ELVDD is electrically isolated from the first node N61.

The scan signal is supplied to the scan line Sn during a second period T2. If the scan signal is supplied to the scan line Sn, the second transistor M62 and the third transistor M63 are turned on. If the second transistor M62 is turned on, the data line Dm is electrically connected with the first node N61. If the third transistor M63 is turned on, the first terminal of the storage capacitor C6st and the gate electrode of the first transistor M61 are electrically connected with the second electrode of the first transistor M61.

The cathode electrode of the OLED is supplied with the voltage of the low state ELVSS(L) during the second period T2. Therefore, the first terminal of the storage capacitor C6st and the gate electrode of the first transistor M61 are provided with the voltage of the low state ELVSS(L) during the second period T2. The voltage of the low state ELVSS(L) is set to a level at which current flows to the second power source ELVSS via the OLED.

Then, the voltage of the high state ELVSS(H) is supplied to the power source line VLn during a third period T3. Therefore, current does not flow to the power source line VLn via the OLED. Correspondingly, the data signal supplied to the data line Dm is supplied to the first terminal of the storage capacitor C6st via the first node N61, the first transistor M61 and the third transistor M63 during the third period T3. Because the first transistor M61 is connected in the diode form, the storage capacitor C6st is charged according to a voltage corresponding to a threshold voltage of the first transistor M61 and the voltage corresponding to the data signal.

The supply of the scan signal to the scan line Sn is interrupted during a fourth period T4. Accordingly, the second transistor M62 and the third transistor are then turned off. If the second transistor M62 is turned off, the first node N61 becomes electrically isolated from the data line Dm. If the third transistor M63 is turned off, the gate electrode of the first transistor M61 becomes electrically isolated from the second electrode of the first transistor M61.

The supply of the light emitting control signal to the light emitting control line En is interrupted during a fifth period T5. If the fourth transistor M64 is turned on, the first power source ELVDD becomes electrically connected with the first node N61.

The voltage of the low state ELVSS(L) is supplied to the power source VLn following the fifth period T5. Then, current flows from the first transistor M61 to the second power source ELVSS via the OLED according to the voltage stored in the storage capacitor C6st. Accordingly, the OLED generates light of a certain or predetermined brightness according to the voltage charged in the storage capacitor C6st.

According to the embodiment of the present invention described above, the respective storage capacitor C6st included in each of the pixels 240 is charged with the voltage corresponding to the threshold voltage of the respective first transistor M61 as well as the voltage corresponding to the respective data signal. As a result, the amount of current flowing into the respective OLED can be better controlled regardless of the threshold voltage of the respective first transistor M61. Therefore, the pixels can be operated to displaying images of uniform brightness. Compared to the pixels of the first embodiment, each of the pixels 240 of the second embodiment, as shown in FIG. 6, includes only four transistors, and therefore it has a structure that is more simple. Furthermore, the wiring configuration of the pixels 240 serves to reduce the size of the pixels 240 as compared to the pixels 140.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A pixel comprising:
an organic light emitting diode having a cathode electrode and an anode electrode;
a first transistor having a first transistor first electrode, a first transistor second electrode, and a first transistor gate electrode;
a second transistor having a second transistor first electrode, a second transistor second electrode, and a second transistor gate electrode;
a third transistor having a third transistor first electrode, a third transistor second electrode, and a third transistor gate electrode; and
a storage capacitor connected between a first power source and the first transistor gate electrode, the storage capacitor having a storage capacitor first terminal and a storage capacitor second terminal,
wherein a power source line is connected with the cathode electrode of the organic light emitting diode and is adapted to provide one of a voltage of a high state and a voltage of a low state,
wherein the second transistor is connected with a data line and a scan line and is adapted to turn on when a scan signal is supplied to the scan line,
wherein the first transistor is connected between the second transistor second electrode and the anode electrode of the organic light emitting diode, and
wherein the third transistor is connected between the first transistor gate electrode and the first transistor second electrode, is connected with the scan line, and is adapted to turn on when the scan signal is supplied to the scan line.

2. The pixel according to claim 1, wherein:
the scan signal is supplied to the scan line during a period, and
the power source line provides the voltage of the low state during a first portion of the period to provide a voltage corresponding to the voltage of the low state at the first transistor gate electrode.

3. The pixel according to claim 2, wherein:
the power source line provides the voltage of the high state during a second portion of the period to provide a voltage corresponding to a data signal supplied to the data line at the storage capacitor first terminal via the second transistor, the first transistor and the third transistor, thereby providing a charging voltage to the storage capacitor, and
the first portion of the period and the second portion of the period are non-overlapping.

4. The pixel according to claim 3, wherein the power source line provides the voltage of the low state upon a charging of the storage capacitor according to the voltage corresponding to the data signal.

5. The pixel according to claim 1, further comprising a fourth transistor having a fourth transistor first electrode, a fourth transistor second electrode, and a fourth transistor gate electrode, wherein:
the fourth transistor is connected between the first power source and the first transistor first electrode,
the fourth transistor gate electrode is connected with a light emitting control line, and
the fourth transistor is adapted to turn off when a light emitting control signal is supplied to the light emitting control line.

6. The pixel according to claim 5, wherein:
the scan signal is supplied to the scan line during a period, and
the light emitting control signal is supplied to the light emitting control line during at least the period to turn off the fourth transistor during the at least the period.

7. The pixel according to claim 1, wherein a level of the voltage of the high state is set equal to a level of a voltage corresponding to the first power source.

8. The pixel according to claim 1, wherein a level of the voltage of the low state is set to be lower than a level of the voltage corresponding to the data signal supplied to the data line.

9. An organic light emitting display device comprising:
a scan driver for supplying scan signals to scan lines in a sequential order and for supplying light emitting control signals to light emitting control lines in a sequential order;
a data driver for supplying data signals to data lines;
a plurality of pixels, each of the plurality of pixels being arranged to be connected with a corresponding one of the scan lines and a corresponding one of the data lines and each of the plurality of pixels including an organic light emitting diode having a cathode electrode and an anode electrode; and
a power supplier for supplying a voltage of a high state to a plurality of power source lines in a sequential order and for supplying a voltage of a low state to power source lines of the plurality of power source lines not supplied with the voltage of the high state,
wherein each of the plurality of power source lines is connected with the cathode electrode of the organic light emitting diode of a corresponding pixel of the plurality of pixels.

10. The organic light emitting display according to claim 9, wherein:
the scan driver supplies one of the scan signals to a corresponding one of the scan lines during a first period,
the scan driver supplies a corresponding one of the light emitting control signals to a corresponding one of the light emitting control lines during a second period, and
the first period overlaps with the second period.

11. The organic light emitting display according to claim 10, wherein the power supplier supplies the voltage of the high state to a corresponding one of the power source lines beginning at a time in the first period.

12. The organic light emitting display according to claim 11, wherein the power supplier supplies the voltage of the low state to the corresponding one of the power source lines after the first period has ended.

13. The organic light emitting display according to claim 9 wherein:
a level of the voltage of the high state is set to a level such that the organic light emitting diode of one of the plurality of pixels does not generate light when the voltage of the high state is supplied to a corresponding one of the power source lines, and
a level of the voltage of the low state is set to a level such that the organic light emitting diode of the one of the plurality of pixels generates light when the voltage of the low state is supplied to the corresponding one of the power source lines.

14. The organic light emitting display according to claim 9, wherein each of the plurality of pixels further comprises:
a first transistor having a first transistor first electrode, a first transistor second electrode, and a first transistor gate electrode;
a second transistor having a second transistor first electrode, a second transistor second electrode, and a second transistor gate electrode;
a third transistor having a third transistor first electrode, a third transistor second electrode, and a third transistor gate electrode; and
a storage capacitor connected between the first power source and the first transistor gate electrode,
wherein, in each of the plurality of pixels, the second transistor is connected with one of the data lines and one of the scan lines and is adapted to turn on when one of the scan signals is supplied to the one of the scan lines,
wherein, in each of the plurality of pixels, the first transistor is connected between the second transistor second electrode and the anode electrode of the organic light emitting diode, and
wherein, in each of the plurality of pixels, the third transistor is connected between the first transistor gate electrode and the first transistor second electrode and is adapted to turn on when the one of the scan signals is supplied to the one of the scan lines.

15. The organic light emitting display according to claim 14,
wherein each of the plurality of pixels further comprises a fourth transistor having a fourth transistor first electrode, a fourth transistor second electrode, and a fourth transistor gate electrode,
wherein, in each of the plurality of pixels, the fourth transistor is connected between the first power source and the first transistor first electrode,
wherein, in each of the plurality of pixels, the fourth transistor gate electrode is connected with a corresponding one of the light emitting control lines, and
wherein, in each of the plurality of pixels, the fourth transistor is adapted to turn off when a light emitting control signal is supplied to the corresponding one of the light emitting control lines.
